(19) United States
(12) Patent Application Publication
(10) Pub. No.: US 2018/0304951 A1
(43) Pub. Date: Oct. 25, 2018

(54) BICYCLE BASKET CAPABLE OF PLACING CUPS

(71) Applicant: GIANT (KUNSHAN) CO., LTD., JIANG SU (CN)

(72) Inventor: Ming-En CHOU, Taichung City (TW)

(21) Appl. No.: 15/961,866

(22) Filed: Apr. 24, 2018

(30) Foreign Application Priority Data
Apr. 25, 2017 (CN) 201710273275.6
Apr. 25, 2017 (CN) 201720436894.8

(51) Int. Cl. B62J 9/00; B62J 11/00

(52) U.S. Cl. CPC B62J 9/003; B62J 11/00

(57) ABSTRACT

A bicycle basket capable of placing a cup includes a basket body and a positioning belt. The basket body includes a bottom portion and a fence. The fence surrounds the bottom portion and includes a first connecting structure and a second connecting structure. The positioning belt is disposed on the fence and has one end connected to the first connecting structure, wherein the positioning belt includes a positioning portion for connecting to the second connecting structure so as to position the cup on the basket body.

### RELATED APPLICATIONS

This application claims priority to China Application Serial Number 201710273275.6, filed Apr. 25, 2017, and China Application Serial Number 201720436894.8, filed Apr. 25, 2017, which are herein incorporated by reference.

### BACKGROUND

### Technical Field

The present disclosure relates to a bicycle basket. More particularly, the present disclosure relates to a bicycle basket which is convenient for placing and positioning cups.

### Description of Related Art

In the modern society, bicycles with small size and high mobility have become the first choice for vehicles moving in metropolitan areas. In order to increase the using convenience of the bicycles, people having ordinary skills in the art are installing baskets on bicycles so as to carry goods.

Conventional bicycle baskets are divided into front baskets and rear baskets. The front basket is disposed on a front portion of a frame of a bicycle (that is, the front basket is disposed in front of a handlebar of the bicycle) so as to look after the goods placed in the front basket. The rear basket is disposed on a rear portion of the frame of the bicycle (that is, the rear basket is disposed on a rear seat of the bicycle) so as to carry heavy goods. Furthermore, in order to increase the application range of the bicycle basket, a cup positioning structure is disposed on the bicycle basket by people in the related field so as to position a cup, a bottle or other related goods.

However, the aforementioned bicycle basket including the cup positioning structure has many limitations in the application. Please refer to FIG. 1 and FIG. 2, FIG. 1 is a schematic view of a cup 11 positioned in a conventional bicycle basket 10, and FIG. 2 is a schematic view of a cup positioning structure (reference number is omitted) of another conventional bicycle basket 20. As shown in FIG. 1, the cup 11 can only be positioned on a bottom of the bicycle basket 10 horizontally, so that the bicycle basket 10 is not suitable for positioned cups which are without sealed or filled with almost full-scale. And as shown in FIG. 2, the bicycle basket 20 includes a limiting ring 21. When a cup (not shown) is positioned within the limiting ring 21, a bottom of the cup is against to a bottom of the bicycle basket 20 so that the cup is supported by the bicycle basket 20. However, when an outer diameter of the cup is larger than a diameter of the limiting ring 21, the cup cannot be placed into the limiting ring 21, and when the outer diameter of the cup is smaller than the diameter of the limiting ring 21, the cup will easily sway due to the vibration impact generated from the bicycle traveling on roads, so that the beverage contained in the cup will be splashed and spilled out from the cup.

Therefore, how to improve and modify the bicycle basket so as to make it easy to place and position the cup, has become the goal of people having ordinary skills in the art.

### SUMMARY

According to one aspect of the present disclosure, a bicycle basket capable of placing a cup includes a basket body and a positioning belt. The basket body includes a bottom portion and a fence. The fence surrounds the bottom portion and includes a first connecting structure and a second connecting structure. The positioning belt is disposed on the fence and has one end connected to the first connecting structure, wherein the positioning belt includes a positioning portion for connecting to the second connecting structure so as to position the cup on the basket body.

### BRIEF DESCRIPTION OF THE DRAWINGS

The present disclosure can be more fully understood by reading the following detailed description of the embodiment, with reference made to the accompanying drawings as follows:

FIG. 1 is a schematic view of a cup positioned in a conventional bicycle basket;

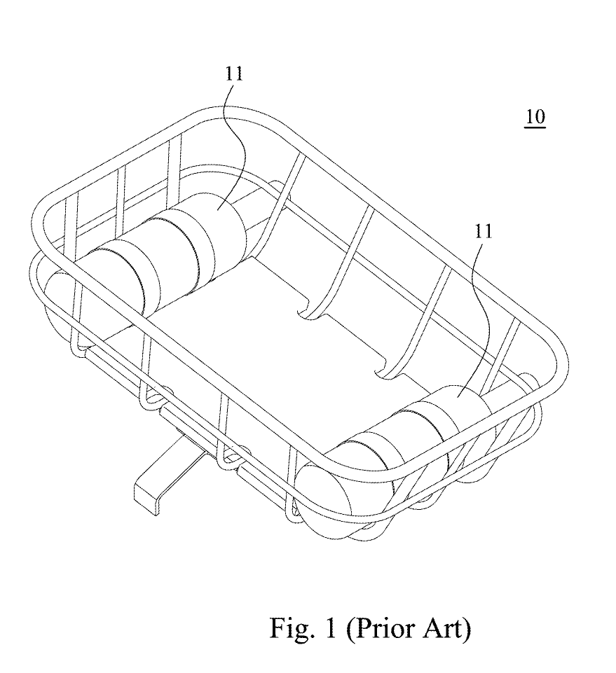

FIG. 2 is a schematic view of a cup positioning structure of another conventional bicycle basket;

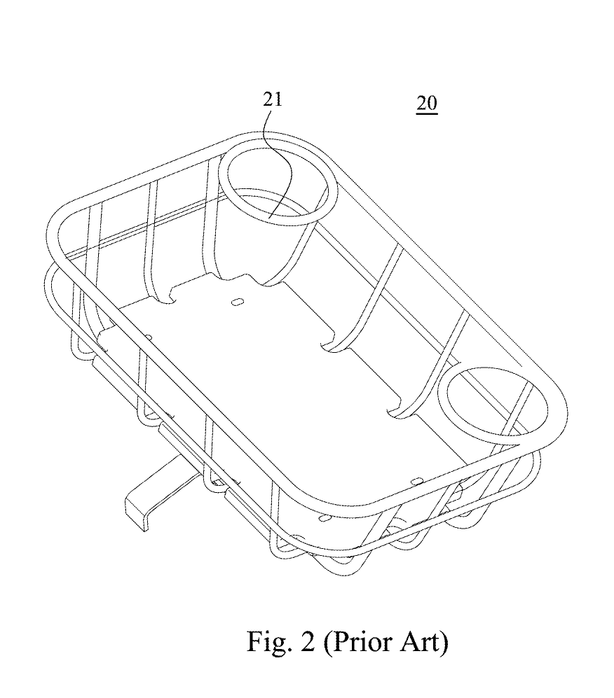

FIG. 3 is a bicycle basket capable of placing a cup according to one embodiment of the present disclosure;

FIG. 4 is a top schematic view of the bicycle basket capable of placing the cup of FIG. 3;

FIG. 5 is a side schematic view of the bicycle basket capable of placing the cup of FIG. 3;

FIG. 6 is a bicycle basket capable of placing a cup according to another embodiment of the present disclosure; and

FIG. 7 is a bicycle basket capable of placing a cup according to still another embodiment of the present disclosure.

### DETAILED DESCRIPTION

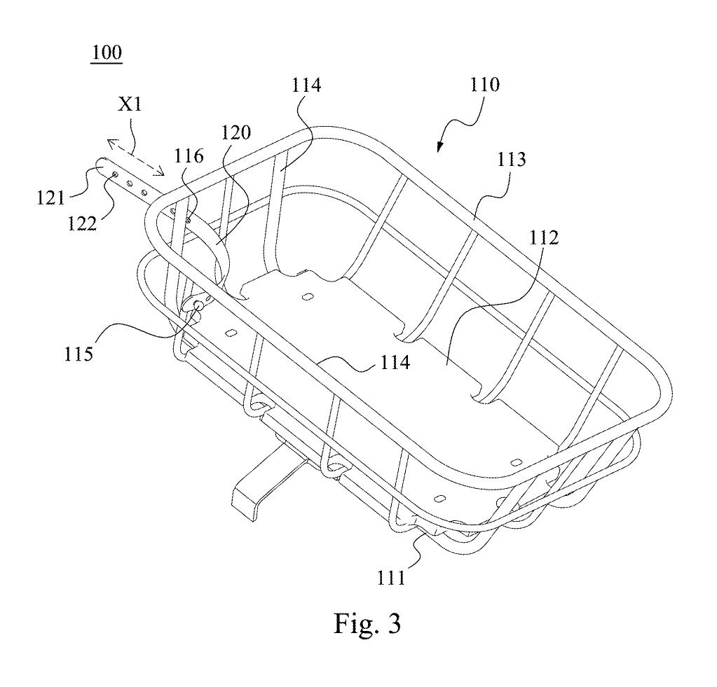

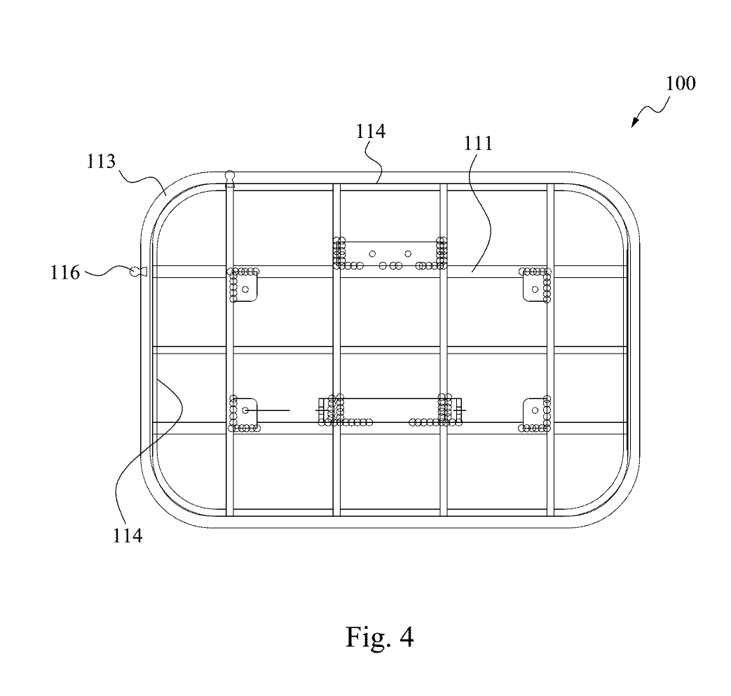

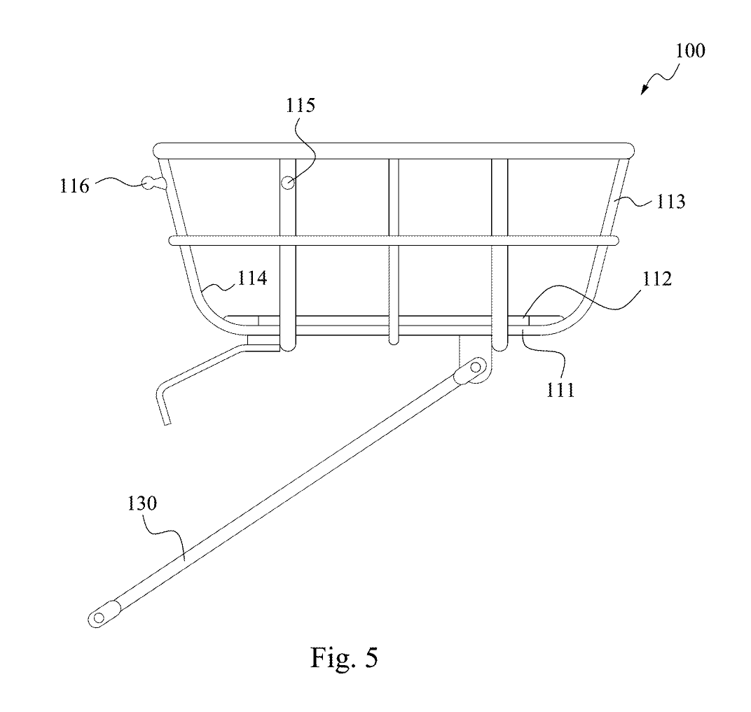

FIG. 3 is a bicycle basket capable of placing a cup 100 according to one embodiment of the present disclosure, FIG. 4 is a top schematic view of the bicycle basket capable of placing the cup 100 of FIG. 3, and FIG. 5 is a side schematic view of the bicycle basket capable of placing the cup 100 of FIG. 3. The bicycle basket capable of placing the cup 100 includes a basket body 110 and a positioning belt 120.

The basket body 110 includes a bottom portion 111 and a fence 113. The fence 113 surrounds the bottom portion 111 and includes a first connecting structure 115 and a second connecting structure (reference number is omitted). The positioning belt 120 is disposed on the fence 113 and has one end connected to the first connecting structure 115, wherein the positioning belt 120 includes a positioning portion 121 for connecting to the second connecting structure so as to position the cup (not shown) on the basket body 110.

In the embodiment of FIG. 3, the positioning portion 121 of the positioning belt 120 includes a plurality of limiting holes 122, the second connecting structure includes a protruding member 116, wherein the limiting holes 122 are disposed on the positioning portion 121 along a long side direction X1 of the positioning belt 120, and the protruding member 116 is assembled with one of the limiting holes 122. Therefore, a size of a cup placing area which is defined by the positioning belt 120 and the basket body 110 can be adjusted by assembling the protruding member 116 with different one of the limiting holes 122 so as to match different outer diameters of different cups. Furthermore, the tightening degree of the positioning belt 120 to the cup can be adjusted so as to position the cup steady, so that the application region of the bicycle basket capable of placing the cup 100 of the present disclosure can be further expanded.

In the embodiment of FIG. 3, the fence 113 is substantially a rectangular frame structure and has four side surfaces 114, wherein two of the side surfaces 114 adjacent to each other form a corner portion (reference number is omitted), and the first connecting structure 115 and the second connecting structure are disposed on the two side surfaces 114 of the corner portion, respectively. Therefore, the cup can be positioned steady on the corner portion of the basket body 110 of the bicycle basket capable of placing the cup 100 by the rectangular frame structure of the fence 113 so as to increase the positioning efficiency of the bicycle basket capable of placing the cup 100 to the cup.

As shown in FIG. 3 and FIG. 5, the basket body 110 can further include a supporting pad 112 disposed on the bottom portion 111. The arrangement of the supporting pad 112 is favorable for placing goods in the bicycle basket capable of placing the cup 100 so as to prevent the cup or other small goods falling from the basket body 110. Furthermore, when the position of the cup is limited by the positioning belt 120, the bottom of the cup is against to the bottom portion 111 and supported by the supporting pad 112, so that the cup positioning efficiency of the bicycle basket capable of placing the cup 100 can be further enhanced.

As shown in FIG. 5, the bicycle basket capable of placing the cup 100 can further include a supporting structure 130 for connecting the basket body 110 to a bicycle (not shown in FIG. 5). However, it must be noted that the supporting structure 130 can be arranged according to actual needs, the bicycle basket capable of placing the cup 100 can be disposed on a front portion (that is, the bicycle basket capable of placing the cup 100 can be a front basket) or on a rear portion (that is, the bicycle basket capable of placing the cup 100 can be a rear basket) of the bicycle via the supporting structure 130, and the present disclosure is not limited to the aforementioned description and figures thereto.

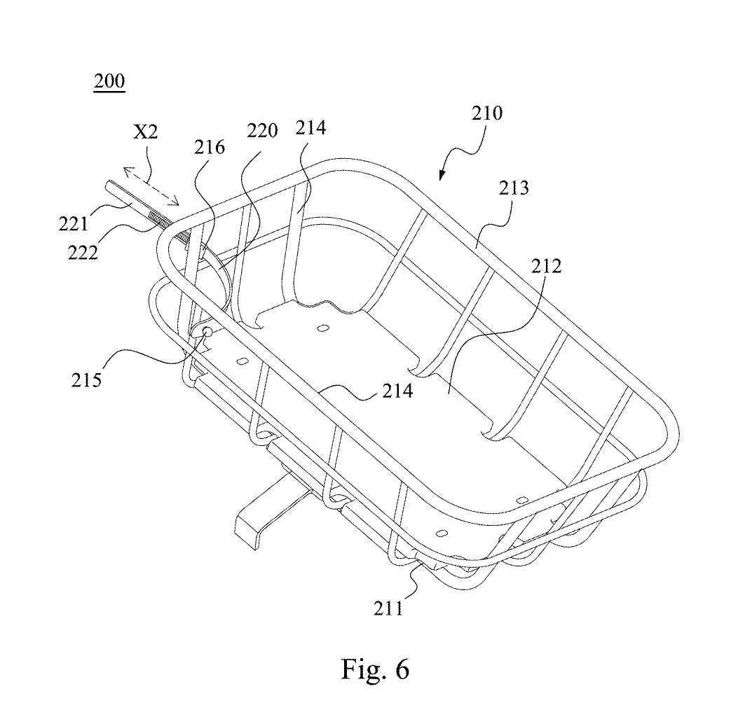

FIG. 6 is a bicycle basket capable of placing a cup 200 according to another embodiment of the present disclosure. The bicycle basket capable of placing the cup 200 includes a basket body 210 and a positioning belt 220.

The basket body 210 includes a bottom portion 211 and a fence 213. The fence 213 surrounds the bottom portion 211, and the positioning belt 220 is disposed on the fence 213. The fence 213 includes a first connecting structure 215 and a second connecting structure (reference number is omitted). One end of the positioning belt 220 is connected to the first connecting structure 215, wherein the positioning belt 220 includes a positioning portion 221 for connecting to the second connecting structure so as to position the cup (not shown) on the basket body 210. In the embodiment of FIG. 6, the positioning portion 221 of the positioning belt 220 includes a plurality of protruding strips 222, the second connecting structure includes a tightening hole 216, wherein the positioning belt 220 passes through the tightening hole 216 and one of the protruding strips 222 is engaged by the tightening hole 216 so as to position the positioning belt 220. Furthermore, as shown in FIG. 6, the protruding strips 222 are parallel disposed on the positioning portion 221 alone a long side direction X2 of the positioning belt 220. Therefore, a size of a cup placing area which is defined by the positioning belt 220 and the basket body 210 can be adjusted by engaging the tightening hole 216 to different one of the protruding strips 222 so as to match different outer diameters of different cups. Moreover, the tightening degree of the positioning belt 220 to the cup can be adjusted so as to position the cup steady, so that the application region of the bicycle basket capable of placing the cup 200 of the present disclosure can be further expanded.

In the embodiment of FIG. 6, the fence 213 is substantially a rectangular frame structure and has four side surfaces 214, wherein two of the side surfaces 214 adjacent to each other form a corner portion (reference number is omitted), and the first connecting structure 215 and the second connecting structure are disposed on the two side surfaces 214 of the corner portion, respectively. Therefore, the cup can be positioned steady on the corner portion of the basket body 210 of the bicycle basket capable of placing the cup 200 by the rectangular frame structure of the fence 213 so as to increase the positioning efficiency of the bicycle basket capable of placing the cup 200 to the cup. In the embodiment of FIG. 6, the basket body 210 can further include a supporting pad 212 disposed on the bottom portion 211. The arrangement of the supporting pad 212 is favorable for placing goods in the bicycle basket capable of placing the cup 200 so as to prevent the cup or other small goods falling from the basket body 210. Furthermore, when the position of the cup is limited by the positioning belt 220, the bottom of the cup is against to the bottom portion 211 and supported by the supporting pad 212, so that the cup positioning efficiency of the bicycle basket capable of placing the cup 200 can be further enhanced.

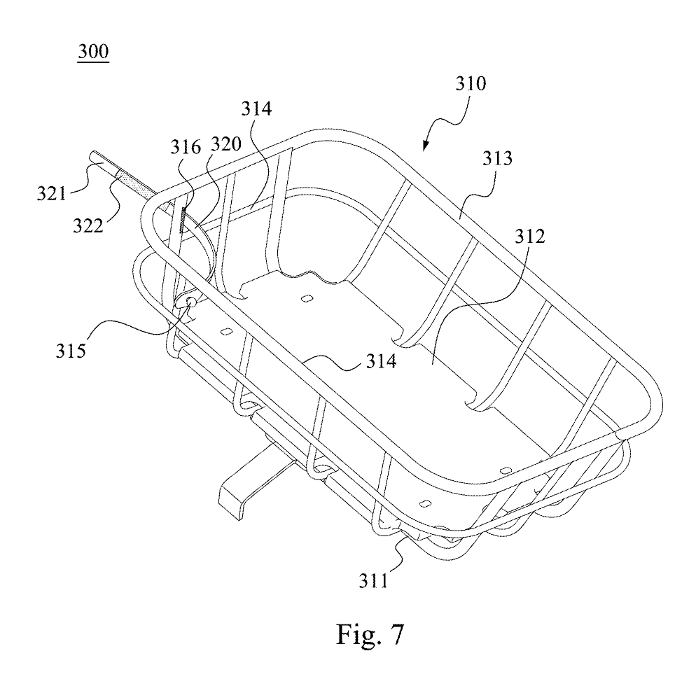

FIG. 7 is a bicycle basket capable of placing a cup 300 according to still another embodiment of the present disclosure. The bicycle basket capable of placing the cup 300 includes a basket body 310 and a positioning belt 320.

The basket body 310 includes a bottom portion 311 and a fence 313. The fence 313 surrounds the bottom portion 311, and the positioning belt 320 is disposed on the fence 313. The fence 313 includes a first connecting structure 315 and a second connecting structure (reference number is omitted). One end of the positioning belt 320 is connected to the first connecting structure 315, wherein the positioning belt 320 includes a positioning portion 321 for connecting to the second connecting structure so as to position the cup (not shown) on the basket body 310. The positioning portion 321 of the positioning belt 320 includes a male member 322 of a hook and loop fastener, the second connecting structure includes a female member 316 of the hook and loop fastener, and the male member 322 of the hook and loop fastener is detachably connected with the female member 316 of the hook and loop fastener. Specifically, in the embodiment of FIG. 7, the male member 322 of the hook and loop fastener can be a loop material, and the female member 316 of the hook and loop fastener can be a hook material. Therefore, a size of a cup placing area which is defined by the positioning belt 320 and the basket body 310 can be adjusted by changing a position of the male member 322 of a hook and loop fastener of the positioning portion 321 connecting to the female member 316 of the hook and loop fastener so as to match different outer diameters of different cups. Furthermore, the tightening degree of the positioning belt 320 to the cup can be adjusted so as to position the cup steady, so that the application region of the bicycle basket capable of placing the cup 300 of the present disclosure can be further expanded.

In the embodiment of FIG. 7, the fence 313 is substantially a rectangular frame structure and has four side surfaces 314, wherein two of the side surfaces 314 adjacent to each other form a corner portion (reference number is omitted), and the first connecting structure 315 and the second connecting structure are disposed on the two side surfaces 314 of the corner portion, respectively. Therefore, the cup can be positioned steady on the corner portion of the basket body 310 of the bicycle basket capable of placing the cup 300 by the rectangular frame structure of the fence 313 so as to increase the positioning efficiency of the bicycle basket capable of placing the cup 200 to the cup. Furthermore, in the embodiment of FIG. 7, the basket body 310 can further include a supporting pad 312 disposed on the bottom portion 311. The arrangement of the supporting pad 312 is favorable for placing goods in the bicycle basket capable of placing the cup 300 so as to prevent the cup or other small goods from falling from the basket body 310. Moreover, when the position of the cup is limited by the positioning belt 320, the bottom of the cup is against to the bottom portion 311 and supported by the supporting pad 312, so that the cup positioning efficiency of the bicycle basket capable of placing the cup 300 can be further enhanced.

According to the aforementioned embodiments, the present disclosure has the advantages described bellowing. First, by the arrangement of an adjustable positioning belt of the bicycle basket capable of placing the cup of the present disclosure, cups or other goods similar thereto can be tight positioned in the basket body. Therefore, the cup positioned in the basket body will not sway when the bicycle is at rest or during driving, so that the demands for easily installing and steady positioning the cup can be further achieved. Second, by the arrangement of the fence with substantially a rectangular frame structure of the bicycle basket capable of placing the cup, and the first connecting structure and the second connecting structure disposed on the corner portion formed by two side surfaces adjacent to each other, the cup can be disposed on a corner portion of the basket body so as to enhance the positioning efficiency of the bicycle basket capable of placing the cup to the cup. Third, by the arrangement of the supporting pad, the bicycle basket capable of placing the cup of the present disclosure can prevent the cup or other small goods from falling from the basket body. Furthermore, when the position of the cup is limited by the positioning belt, the bottom of the cup is against to the bottom portion and supported by the supporting pad, so that the cup positioning efficiency of the bicycle basket capable of placing the cup can be further enhanced.

Although the present disclosure has been described in considerable detail with reference to certain embodiments thereof, other embodiments are possible. Therefore, the spirit and scope of the appended claims should not be limited to the description of the embodiments contained herein.

It will be apparent to those skilled in the art that various modifications and variations can be made to the structure of the present disclosure without departing from the scope or spirit of the disclosure. In view of the foregoing, it is intended that the present disclosure cover modifications and variations of this disclosure provided they fall within the scope of the following claims.

What is claimed is:

1. A bicycle basket capable of placing a cup, comprising:
a basket body, comprising;
a bottom portion; and
a fence surrounding the bottom portion and comprising a first connecting structure and a second connecting structure; and
a positioning belt disposed on the fence and having one end connected to the first connecting structure, wherein the positioning belt comprises a positioning portion for connecting to the second connecting structure so as to position the cup on the basket body.

2. The bicycle basket capable of placing the cup of claim 1, wherein the positioning portion of the positioning belt comprises a plurality of limiting holes, the second connecting structure comprises a protruding member, and the protruding member is assembled with one of the limiting holes.

3. The bicycle basket capable of placing the cup of claim 2, wherein the limiting holes are disposed on the positioning portion along a long side direction of the positioning belt.

4. The bicycle basket capable of placing the cup of claim 1, wherein the positioning portion of the positioning belt comprises a plurality of protruding strips, the second connecting structure comprises a tightening hole, wherein the positioning belt passes through the tightening hole and one of the protruding strips is engaged by the tightening hole so as to position the positioning belt.

5. The bicycle basket capable of placing the cup of claim 4, wherein the protruding strips are parallel disposed on the positioning portion along a long side direction of the positioning belt.

6. The bicycle basket capable of placing the cup of claim 1, wherein the positioning portion of the positioning belt comprises a male member of a hook and loop fastener, the second connecting structure comprises a female member of the hook and loop fastener, and the male member of the hook and loop fastener is detachably connected with the female member of the hook and loop fastener.

7. The bicycle basket capable of placing the cup of claim 6, wherein the male member of the hook and loop fastener is a loop material, and the female member of the hook and loop fastener is a hook material.

8. The bicycle basket capable of placing the cup of claim 1, 2, 3, 4 or 5, wherein the basket body further comprises:
a supporting pad disposed on the bottom portion.

9. The bicycle basket capable of placing the cup of claim 1, wherein the fence is substantially a rectangular frame structure and has four side surfaces, wherein two of the side surfaces adjacent to each other form a corner portion, and the first connecting structure and the second connecting structure are disposed on the two side surfaces, respectively.

10. The bicycle basket capable of placing the cup of claim 1, further comprising:
a supporting structure for connecting the basket body to a bicycle.
